(19) United States
(12) Patent Application Publication
(10) Pub. No.: US 2005/0249851 A1
(43) Pub. Date: Nov. 10, 2005

(54) Taint removal from wine

(76) Inventor: David Wollan, Doncaster (AU)

Correspondence Address: HARNESS, DICKEY & PIERCE, P.L.C., P.O. BOX 828, BLOOMFIELD HILLS, MI, 48303, US

(21) Appl. No.: 10/860,624

(22) Filed: Jun. 3, 2004

(30) Foreign Application Priority Data
May 7, 2004 (AU) 2004201949

(51) Int. Cl. C12H 1/04

(52) U.S. Cl. 426/422

(57) ABSTRACT

A method of treatment of wine to reduce the concentration of at least one predetermined component thereof including the steps of: (i) processing the wine by reverse osmosis or nanofiltration for producing a retentate and a raw permeate, the raw permeate containing the predetermined component; (ii) treating the raw permeate with at least one adsorptive medium for removing at least a portion of the predetermined component and for producing a purified permeate; and (iii) combining the retentate with the purified permeate for producing treated wine in which the predetermined component is reduced.

### FIELD OF THE INVENTION

This invention relates to removal of compounds from wine which cause tainting thereof.

### BACKGROUND OF THE INVENTION

There are a number of taints in wine that are associated with the presence in wine of excessive levels of certain low molecular weight volatile phenolic compounds such as:
(i) guaiacol(2-methoxyphenol MW=124.1);
(ii) 4-methylguaiacol (2-methoxy-4 methylphenol MW=138.2);
(iii) 4-ethylphenol (MW=122.2); and
(iv) 4-ethylguaiacol (4-ethyl-2-methoxyphenol MW=152.2).

For example, bush fire smoke has been found to contaminate grapes in the vineyard and the wines from these grapes have been found to have elevated concentrations of guaiacol and 4-methylguaiacol. Wines that have been infected with the spoilage yeast Brettanomyces spp. have been found to contain high levels of 4-ethylphenol and 4-ethylguaiacol. While these may not be the only compounds associated with the perception of tainted aroma and taste, it is generally regarded that they have a major role.

These compounds, however, are chemically similar to other desirable wine components and any of the traditional treatments for ameliorating wine will not remove the taints without also reducing wine colour, body and flavour. Specification AU-B-42319/93 discloses one technique for removal of unwanted compounds from wine. That technique involves two processing stages, the first including passing the wine through a reverse osmosis unit and then passing the raw permeate to a second processing stage for removal of the unwanted compounds. The second processing stage can be an anion exchange or distillation column. An anion exchange and distillation column are not normally found in wineries and therefore it is not really practical to implement this system onsite at a winery where it is most convenient for treatment of the wine.

### SUMMARY OF THE INVENTION

The object of the present invention is to provide a novel method and apparatus for removal of certain taint compounds from wine without also reducing the concentration of other desirable characters in the wine.

According to the present invention there is provided a method of treatment of wine to reduce the concentration of at least one predetermined component thereof including the steps of:
(i) processing the wine by reverse osmosis or nanofiltration for producing a retentate and a raw permeate, the raw permeate containing the predetermined component;
(ii) treating the raw permeate with at least one adsorptive medium for removing at least a portion of the predetermined component and for producing a purified permeate; and
(iii) combining the retentate with the purified permeate for producing treated wine in which the predetermined component is reduced.

The invention also provides apparatus for removal of at least one predetermined component thereof, the apparatus including:
a first processing stage having a reverse osmosis unit or nanofiltration unit having a retentate outlet and a permeate outlet;
a pump for supplying wine to be treated under pressure to said first processing stage whereby retentate is produced at said retentate outlet and raw permeate containing said predetermined component is produced at the permeate outlet;
a second processing stage which includes at least one adsorptive medium, the second processing stage having an inlet for receiving said raw permeate, the adsorptive medium being operable to remove at least a portion of said predetermined component and produce a purified permeate at an outlet of the second processing stage; and
means for combining said retentate and said purified permeate to thereby produce treated wine in which the predetermined component is reduced.

### BRIEF DESCRIPTION OF THE DRAWINGS

The invention will now be further described with reference to the accompanying drawings, in which:

FIG. 1 is a schematic diagram of a preferred embodiment of the invention; and

FIG. 2 is a schematic diagram of an alternative embodiment of the invention.

### DETAILED DESCRIPTION

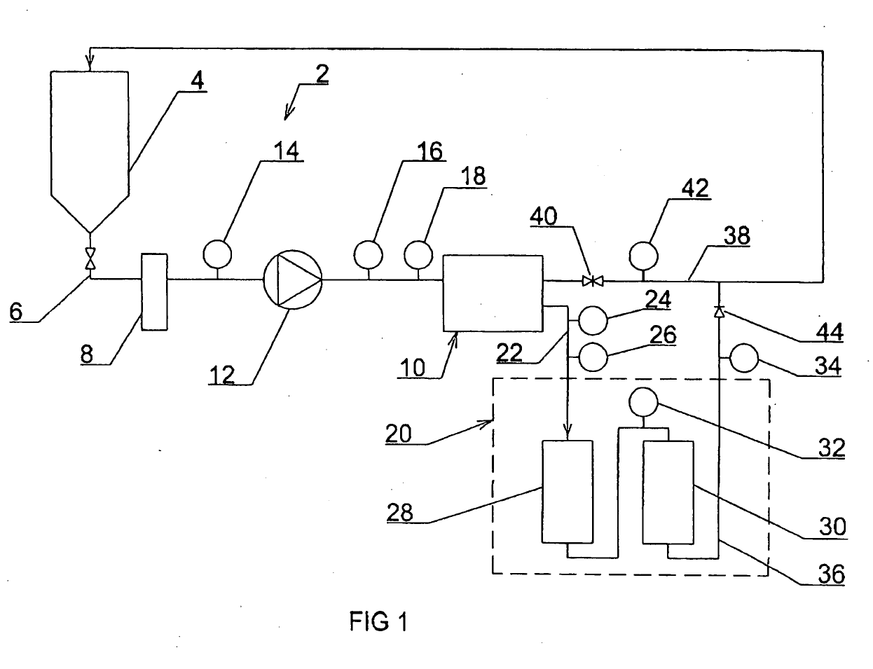

Referring first to FIG. 1, there is shown an apparatus 2 for removal of taints in wine. The apparatus includes a storage tank 4 for wine to be treated. An outlet line 6 passes to a screen filter 8 which has a 1 mm screen for removal of larger solid components from the wine. The wine then is pumped to a first processing stage 10 by means of a pump 12. A flow meter 14 is connected between the filter 8 and the pump 12 and pressure and temperature sensors 16 and 18 are connected between the pump 12 and the first processing stage 10, as indicated.

The first processing stage 10 may be a reverse osmosis unit or a bank of filters having nanofiltration membranes therein. As will be apparent to those skilled in the art, with modern membranes there is little technical difference between nanofiltration and reverse osmosis. The main difference is the relative permeability of the membranes to components of varying molecular weight and charge.

The first processing stage 10 is arranged to produce a permeate which includes compounds below a predetermined molecular weight such as 150 to 300. The permeate stream which consists of water, ethanol, certain low molecular weight organic compounds and some monovalent ions, is generated. It contains no colour and little wine flavour but appears to be relatively rich in taint characters.

Membranes used in the first processing stage may be of the reverse osmosis or nanofiltration type. To be effective they need to pass significant quantities of the taint compounds but reject most other, desirable wine components. All of the volatile phenols associated with taint are generally non-charged in the wine and have molecular weights, between 120 and 160. Other phenolic compounds found in wine fall into three broad categories:
(i) Benzoic acid derivatives: gallic acid (MW 170), vanillic acid (MW 168), syringic acid (MW 198), ellagic acid (MW 320);
(ii) Cinnamic acid derivatives: cinnamic acid (MW 148), coumaric acid (MW 146), caffeic acid (MW 180), ferulic acid (MW 194); and
(iii) Flavanoid derivatives: catechin (MW 290), anthocyanins (MW>400), and polymeric assemblies of these.

Of these, the flavanoid derivatives are those most closely associated with wine colour and taste. Therefore, it is preferable that the selected membranes should reject these compounds.

One such membrane is GE Osmonics VinoPro™ 4040C-30D. This is a proprietary thin film nanofiltration membrane in a spiral wound construction. It is available in various size configurations which may be chosen according to performance requirements. The advantage of the spiral wound arrangement is that large filter surface areas may be available in a relatively small overall volume.

Membrane performance is typically measured in flux of permeate and relative passage and rejection of the compounds to be separated. It varies with the osmotic pressure, clarity and temperature of the wine being treated.

Preferably the temperature of the wine should be between 15° C. and 25° C. to optimise flux without compromising wine character.

Preferably the operating pressure should be between 1,000 and 3,500 kPa. At higher pressures, the flux increases but the passage of taint compounds decreases. At lower pressures, the flux is so low that large membrane surface areas are required for satisfactory system performance.

The membrane performance with regard to its selectivity i.e. rejection of more desirable high molecular weight compounds may be improved by operation at higher pressure.

Preferably the wine in the tank 4 should be initially clarified using known techniques such that grape and other suspended solids do not foul the membranes. For optimum membrane performance, the clarity as measured by turbidity should be less than 50 NTU.

Under these conditions, the permeate flux would be 15-20 litres per square metre of membrane area per hour. Observed passage of indicator compounds guaiacol and 4-ethylphenol are in the range of 50% to 60% through the membranes.

A typical operating configuration of sixteen membranes comprises approximately 120 square metres of membrane surface area and permeate flux is 1,800 to 2,400 litres per hour. The membranes were arranged in two parallel banks, each having eight membranes connected in series.

The permeate passes to a second processing stage 20 via a permeate line 22. A second flow meter 24 is connected in the line 22 so as to sense the flow rate in the line 22. A first UV absorbance detector 26 is also connected in the line 22. The absorbance detector preferably comprises a UV/visible spectrophotometer which can be arranged to detect at say 280 nm. The absorbance detector indirectly detects the aggregate concentration of taint compounds which are generally phenolic in nature and have an absorbance peak at about 280 nm. Other analytical tools would be available such as gas chromatography and mass spectrometry equipment but these are not often found in wineries and offsite analytical services would not be suitable because, generally speaking, a real time indication of the degree of removal of the taint forming compounds is required.

Generally speaking, the second processing stage 20 is arranged to reduce the concentration of taint forming compounds in the permeate by adsorption. In the illustrated arrangement, there is a first adsorptive medium housing 28 which includes polyvinylpolypyrollidone (PVPP). The second stage includes a second adsorptive medium housing 30 which includes activated carbon. It is preferred that the PVPP is located in the first absorptive medium housing 28 because it is more selective in its removal of the taint forming compounds than activated carbon. Accordingly the permeate in the line 22 should pass to the PVPP before the activated carbon.

Both activated carbon and polyvinylpolypyrollidone (PVPP) have been found to be successful in reducing the concentration of taint compounds in the permeate stream.

PVPP is preferred because it is specific in its adsorption of low molecular weight phenolic compounds. It has the further benefit of being regenerable by treatment with caustic soda.

Activated carbon is less specific in its adsorption of organic compounds but it may have a supplementary benefit in its removal of other possibly undesirable compounds such as fusel oils, higher alcohols and longer chain fatty acids which may also pass the membrane.

The adsorptive media may be utilised in various forms:
(i) by passing the permeate directly through the one or both media immobilised in filter sheets or cartridges such as Carlson Prop4, Amazon BP, Cuno Zeta Plus Activated Carbon;
(ii) by passing the permeate directly through one or both media contained in bulk beds;
(iii) by collecting the permeate in a separate vessel; treating in place with the adsorptive media and filtering back to the original; and
(iv) by dosing the medium into the permeate stream and then removing it by filtration before the stream is returned to the wine.

The most suitable form will be determined by the particular requirements of the application such as the need for equipment mobility, the availability of holding vessels and suitable filtration equipment.

In the case of the adsorptive medium being immobilised in filter sheets, cartridges or bulk beds, flow rates of permeate would need to be adjusted to ensure adequate residence time for the taint compounds to be adsorbed. In the case of the Amazon BP carbon block filters, flow rate should be restricted to 600 litres per hour per 20″ cartridge. PVPP is preferably packed in cartridge form for convenient use in the method of the invention.

For a carbon block filter such as the Amazon BP described above, the approximate residence time for permeate being treated should be greater than three seconds and preferably greater than about five seconds.

A PVPP filter cartridge of 660 ml cubic capacity would require similar residence times.

Second and third absorbance detectors 32 and 34 are preferably provided for monitoring the permeate between the housings 28 and 30 and in the outlet line 36 from the second housing 30 respectively.

Ideally, a real time analysis of the treated permeate's volatile phenol content would verify the efficacy of the process. However, this analysis is relatively sophisticated and requires gas chromatograph and mass spectrometry equipment that is not common in wineries. Off site contracted analytical services are available but these are slow and expensive. As a real time tool for determining the extent of processing, they are not practical.

UV/visible spectrophotometers are more readily found in wineries so a monitoring and control methodology based on the measurement of absorbance is proposed in accordance with the invention. The methodology is based on the taint compounds in question being phenolic in nature and having an absorbance peak at about 280 nm.

Samples of permeate before and after adsorption Treatment are taken at regular intervals during processing and the absorbance at 280 nm is measured against a water blank. A significant reduction in absorbance has been noted and the extent of this is a useful, indirect measure of system efficacy.

Further, the absorbance can be correlated with standard additions of known amounts of the taint compounds and the process calibrated.

Subsequent analysis of the permeate and wine before and after treatment would allow verification and calibration of the process.

Alternatively, measurement could be by means of inline fixed wavelength detectors which would monitor the absolute as well as differential absorbance at 280 nm. Output from this device could be processed by programmable logic controller (not shown) and operating parameters such as pressure and flow rate could be optimised.

The first processing stage 10 includes a retentate outlet line 38 which is arranged to return the retentate back to the wine in the tank 4, as shown. The line 38 includes a back pressure control valve 40 and pressure sensor 42 which are arranged to control the effective pressure drop across the first stage 10. The outlet line 36 from the second processing stage is connected to the outlet line 38 via a non-return valve 44 so that the permeate having the taint compounds removed therefrom in the second processing stage 20 is also returned to the tank 4.

The process is continued until a predetermined amount of the taint compounds are removed from the wine by adsorption within the second stage 20. This can be monitored by observation of the absorbance detectors 26, 32 and 34 which will show a gradual reduction in the concentration of the taint forming compounds. In the illustrated arrangement, there are three absorbance detectors 26, 32 and 34. It would be possible to use a single detector which can be selectively coupled to sampling points corresponding to the points where the detectors 26, 32 and 34 are connected, as shown in FIG. 1. In addition or as an alternative to absorption monitoring, taint removal could be monitored by regular tasting of the wine in the tank 4.

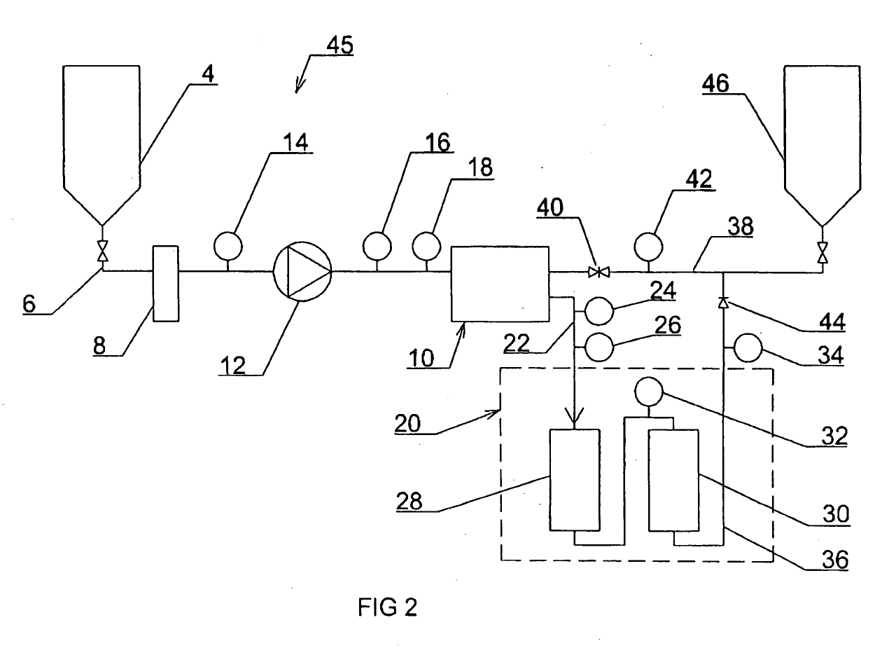

FIG. 2 illustrates a modified apparatus 45 for removal of taint compounds from wine. In this arrangement, the same reference numerals have been used to denote parts which are the same as or correspond to those of the first embodiment. The main difference between the apparatus 45 and the apparatus 2 is that the outlet line 38 does not return wine to the wine tank 4 but instead passes it to a treated wine tank 46. In some circumstances, a single pass of wine through the first and second treatment stages 10 and 20 is all that would be needed to remove sufficient taint components from the wine. Alternatively, where the level of contamination is high and/or the rate of removal of the unwanted components is comparatively low, the wine can undergo two, three, four or more passes through the apparatus 45 in order to reduce the taint components to a level which is regarded as satisfactory.

Some Examples of the methods of the invention are discussed below.

### EXAMPLE 1

### Smoke Taint Removal Trial

A 1,000 litre batch of 2003 vintage Merlot wine was offered for a trial treatment to determine the effectiveness of the process. The wine was smoke affected because the grapes were subject to bush fire smoke over a period of about a week or more.

Apparatus similar to that shown in FIG. 1 was used except that the second processing stage 20 utilised only the housing 30 containing activated carbon, there being no PVPP filtration. The first processing stage 10 utilised a single VinoPro 4040C-30D membrane.

Samples of the original wine were taken before processing commenced and the processed wine was monitored for aroma and taste at regular intervals. When it was felt the wine had improved sufficiently, the process was terminated and final samples taken for later analysis of guaiacol and 4-methylguaiacol.

Processing commenced at 0945 with a product temperature of 12° C. and operating pressure of 1,500 kPa. Under these conditions a permeate flux of 60 litres per hour was achieved. At 8 l/m²/hour this was below the hoped for flux. Pressure was then increased to 2,500 kPa and processing continued for a total 616 minutes during which time 1292 litres of permeate were processed, giving an overall flux of 16.8 l/m²/hour. Over the course of processing the temperature increased to 20° C.

The results of analyses for samples taken before and after processing were as set out in Table 1 below:

TABLE 1

| | Original Wine μg/l | After Processing μg/l |
|---|---|---|
| Guaiacol | 35 | 25 |
| 4-methylguaiacol | 11 | 7 |

There was also an observed significant reduction in “smokiness” by a panel of tasters and the process was regarded as successful.

### EXAMPLE 2

### Brettanomyces Taint Removal Trial

A 2,200 litre quantity of 2002 Shiraz was offered for treatment. This had been previously analysed as having an elevated level of 4-ethylphenol consistent with a Brettanomyces infection. It was proposed to treat the wine in a similar manner to the treatment of the smoke tainted wine described above.

In the first processing stage 10, the wine was circulated through two parallel banks, each consisting of eight VinoPro 4040C-30D membranes in series. The permeate from this was then passed to the second processing stage 20 having a filter housing containing three new carbon filter cartridges (500 mm Amazon BP carbon block) and returned to the product stream. Operating pressures were varied in the range of 1,500 to 3,000 kPa to observe the effect on flux and the passage of taint characters into the permeate. Over the course of the process the wine temperature increased from 14° C. to 19° C.

Processing continued for 214 minutes until 2,200 litres of permeate had been processed. It was felt that the wine was still being improved by the process so it was recommenced for a further 70 minutes until a total 3,300 litres of permeate had been processed. At different pressures the flux varied from 400 to 1,560 litres per hour but for the whole trial the overall flux averaged 700 litres per hour or approximately 6 l/m²/hour.

At the end of this process, samples were taken for analysis. The results are set out in Table 2 below.

TABLE 2

| | Original Wine μg/l | After Processing μg/l |
|---|---|---|
| 4-ethylphenol | 970 | 550 |

### EXAMPLE 3

### Spectrometric Analysis of Permeate During Processing

In an attempt to better quantify the effect of processing under different conditions, trials were conducted to measure the UV spectrophotometric absorbance of the permeate at 280 nm. It is known that 4-ethylphenol has an absorbance peak at this part of the spectrum and because of the general similarity of This compound with other taint forming compounds, it is assumed that these other compounds will also have an absorbance peak at about 280 mm.

In the first processing stage 10, the wine being treated was passed through two banks of eight VinoPro 4040C-30D membranes in tank-to-tank (non recirculation) mode as shown in FIG. 2. Pressure was maintained between 2,600 and 2,800 kPa; wine temperature was 22° C.; flux was approximately 1,350 litres per hour. The permeate was then passed to the second stage 20 which included two filter housings in series. Each of these contained three Amazon carbon block filters (06 BP, 500 nm). The lead housing contained new filters and the second housing contained filters that were previously in the lead housing. When it was judged by tasting the permeate that the second housing was exhausted, i.e. passing taint compounds, these would be removed and the lead housing filter cartridges would be replaced and these would then become the second housing filters. The amount of permeate that could be treated before replacement was necessary, varied from wine to wine but from experience it generally fell in the range of 6,000 to 10,000 litres per set of three cartridges of the type defined above.

During the course of treatment of these smoke affected wines, permeate samples were taken prior to any carbon filtration, after the lead housing 28 and after the second housing 30. Their absorbance was then measured with a single beam laboratory UV-visible spectrophotometer (wavelength −280 nm, 10 mm glass cuvettes, distilled water blank). The results are set out in Table 3 below.

TABLE 3

| Litres Permeate | Absorbance | Absorbance | Absorbance |
|---|---|---|---|
| Treated | Pre | Post 1 | Post 2 |
| 696 | 0.600 | 0.324 | 0.043 |
| 1398 | 0.520 | 0.319 | 0.183 |
| 2092 | 0.530 | 0.336 | 0.210 |
| 2789 | 0.529 | 0.359 | 0.231 |
| 3464 | 0.520 | 0.370 | 0.234 |
| 4142 | 0.510 | 0.366 | 0.249 |
| 4814 | 0.542 | 0.403 | 0.262 |
| 5514 | 0.525 | 0.400 | 0.272 |
| 6129 | 0.525 | 0.418 | 0.291 |
| 6776 | 0.537 | 0.412 | 0.288 |
| 8039 | 0.525 | 0.409 | 0.298 |
| 8424 | 0.536 | 0.428 | 0.307 |

These results show that there was a steady increase in absorbance after the two stages of carbon filtration over the course of the process. This appeared to correlate with the subjective impression of taint passage and, at that point, it was felt that the filters needed to be changed.

The results shown in Table 3 above demonstrate that spectrophotometric analysis of the permeate can be used as a practical tool in the process of the invention. The results can be used to better control operating pressures and also to determine when filter material used in the second processing stage 20 has become exhausted.

Many modifications will be apparent to those skilled in the art without departing from the spirit and scope of the invention.

1. A method of treatment of wine to reduce the concentration of at least one predetermined component thereof including the steps of:
(i) processing the wine by reverse osmosis or nanofiltration for producing a retentate and a raw permeate, the raw permeate containing the predetermined component;
(ii) treating the raw permeate with at least one adsorptive medium for removing at least a portion of the predetermined component and for producing a purified permeate; and
(iii) combining the retentate with the purified permeate for producing treated wine in which the predetermined component is reduced.

2. A method as claimed in claim 1 wherein the step of treating the raw permeate includes the step of passing of the permeate through a first adsorptive medium and then through a second adsorptive medium.

3. A method as claimed in claim 2 wherein the first adsorptive medium is polyvinylpolypyrollidone (PVPP) and the second adsorptive medium is activated carbon.

4. A method as claimed in claim 1 including the steps of determining the absorbance of the raw and purified permeate at a predetermined wavelength in order to monitor the levels of said predetermined component.

5. A method as claimed in claim 4 wherein the predetermined wavelength is about 280 nm.

6. A method as claimed in claim 4 wherein the steps of determining the absorbance of the raw and purified permeate is carried out by one or more UV/visible spectrophotometers.

7. A method as claimed in claim 1 including the step of storing the wine to be treated in a tank and the method includes the step of returning the combined retentate and purified permeate to said tank.

8. A method as claimed in claim 1 including the step of storing the wine to be treated in a tank and the method includes the step of storing the combined retentate in a second tank.

9. A method as claimed in claim 8 wherein wine from the second tank is reprocessed.

10. A method as claimed in claim 1 wherein the wine is clarified prior to step (i).

11. A method as claimed in claim 10 wherein the turbidity of the wine is less than 50 NTU after clarification.

12. A method as claimed in claim 1 wherein the step of processing the wine by reverse osmosis or filtration includes the step of passing the wine under pressure to a filtration unit which includes one or more membranes.

13. A method as claimed in claim 12 wherein the membrane or membranes are selected to pass said predetermined component to said permeate.

14. A method as claimed in claim 12 wherein the membrane or membranes pass compounds having a predetermined nominal molecular weight.

15. A method as claimed in claim 14 wherein said nominal molecular weight is in the range 150 to 300.

16. A method as claimed in claim 15 wherein the membrane is a type 4040C-30D VinoPro.

17. A method as claimed in claim 1 wherein the predetermined component is a volatile phenolic compound which causes tainting.

18. A method as claimed in claim 17 wherein the compound is:
(i) guaiacol (2-methoxyphenol MW=124.1);
(ii) 4-methylguaiacol (2-methoxy-4 methylphenol MW=138.2);
(iii) 4-ethylphenol (MW=122.2); and/or
(iv) 4-ethylguaiacol (4-ethyl-2-methoxyphenol MW=152.2).

19. Wine treated by the method of claim 1.

20. Apparatus for removal of at least one predetermined component thereof, the apparatus including:
a first processing stage having a reverse osmosis unit or nanofiltration unit having a retentate outlet and a permeate outlet;
a pump for supplying wine to be treated under pressure to said first processing stage whereby retentate is produced at said retentate outlet and raw permeate containing said predetermined component is produced at the permeate outlet;
a second processing stage which includes at least one adsorptive medium, the second processing stage having an inlet for receiving said raw permeate, the adsorptive medium being operable to remove at least a portion of said predetermined component and produce a purified permeate at an outlet of the second processing stage; and
means for combining said retentate and said purified permeate to thereby produce treated wine in which the predetermined component is reduced.

21. Apparatus as claimed in claim 20 wherein the second processing stage includes first and second adsorptive medium housings 28 and 30 which respectively contain first and second adsorptive media.

22. Apparatus as claimed in claim 21 wherein the first adsorptive medium is polyvinylpolypyrollidone (PVPP) and the second adsorptive medium is activated carbon.

23. Apparatus as claimed in claim 20 including monitoring means for monitoring the levels of said predetermined component in the raw and purified permeates.

24. Apparatus as claimed in claim 23 wherein the monitoring apparatus includes one or more UV/visible spectrophotometers.

25. Apparatus as claimed in claim 20 including a storage tank for storing wine to be treated and wherein said means for combining said retentate and said purified permeate is operable to return the combined retentate and purified permeate to said tank.

26. Apparatus as claimed in claim 20 wherein the apparatus includes first and second tanks, the first tank for containing the wine to be treated and wherein the means for combining said retentate and said purified permeate is operable to deliver the combined retentate and purified permeate to said second tank.

27. Apparatus as claimed in claim 20 wherein the reverse osmosis unit or the nanofiltration unit includes one or more membranes which are operable to pass compounds having a predetermined nominal molecular weight.

28. Apparatus as claimed in claim 27 wherein said nominal molecular weight is in the range from 150 to 300.

29. Apparatus as claimed in claim 28 wherein the membrane is a type 4040C-30D VinoPro.
